(19) United States
(12) Patent Application Publication
(10) Pub. No.: US 2026/0162064 A1
(43) Pub. Date: Jun. 11, 2026

(54) CONSUMABLE PRODUCT MANAGEMENT SYSTEM AND DEVICE

(71) Applicant: Zoltan Hatos, Sedona, AZ (US)

(72) Inventors: Zoltan Hatos, Sedona, AZ (US); Jozsef Hatos, Sedona, AZ (US)

(21) Appl. No.: 19/414,789

(22) Filed: Dec. 10, 2025

Related U.S. Application Data
(60) Provisional application No. 63/730,200, filed on Dec. 10, 2024.

(51) Int. Cl. G06Q 10/087; G07F 9/02

(52) U.S. Cl. CPC G06Q 10/08772; G07F 9/026

(57) ABSTRACT

A consumable product management device and system are provided. A consumable product management device may include a product plate having a product support surface, and a weight sensor coupled to the product plate. The weight sensor may be configured to generate weight data that describes the weight of a consumable product container that is placed on the product plate. A multi-protocol RFID reader may be configured to receive wireless electronic data describing the consumable product container from a transponder that is coupled to the consumable product container. A component cover may be coupled to the product plate and to a first and a second electronic coupler that may each be in electronic communication with the weight sensor and the multi-protocol RFID reader, and the first electronic coupler may be configured to communicate electric power to the second electronic coupler, to the weight sensor, and to the multi-protocol RFID reader.

### CROSS REFERENCE TO RELATED APPLICATIONS

This application claims priority to and the benefit of the filing date of U.S. Provisional Application No. 63/730,200, filed on Dec. 10, 2024, entitled “CONSUMABLE PRODUCT MANAGEMENT SYSTEM AND DEVICE”, which is hereby incorporated by reference in its entirety.

### FIELD OF THE INVENTION

This patent specification relates to the field of product management systems and devices, and particularly to a system and device that may be used to manage consumable product inventories, such as consumable products that are dispensed from containers.

### BACKGROUND

Many service industries utilize a business method that relies on dispensing consumable products from bulk storage containers. These service industries need to effectively manage their inventory of consumable products to effectively control costs, prevent waste, maximize profits, and maintain accurate stock levels by tracking the usage and inventory levels of the consumable products, allowing them to identify areas of excessive consumption, theft, or waste, and make informed decisions about ordering and restocking to avoid shortages or overstocking. Unfortunately, existing product management systems are time and labor intensive, typically relying on employees to periodically handle and/or observe each consumable product bulk storage container. This leads to increased costs and inaccuracies due to human error.

Therefore, a need exists for novel systems and devices that may be used to manage product inventories, such as consumable products that are dispensed from containers. There is also a need for novel product management systems and devices which are not time and labor intensive to operate, integrate seamlessly to traditional business operations, and which offer improved and increased functionality over existing systems and devices.

### BRIEF SUMMARY OF THE INVENTION

A consumable product management device and system are provided. A consumable product management system may include one or more consumable product management devices, such as a first consumable product management device and a second consumable product management device, etc. In some embodiments, the device may include a product plate having a product support surface, and a weight sensor may be coupled to the product plate. The weight sensor may be configured to generate weight data that describes the weight of a consumable product container that is placed on the product plate. A multi-protocol RFID reader may be configured to receive wireless electronic data describing the consumable product container from a transponder that is coupled to the consumable product container. A component cover may be coupled to the product plate, and a first electronic coupler and a second electronic coupler may be coupled to the component cover. The first electronic coupler and the second electronic coupler may each be in electronic communication with the weight sensor and the multi-protocol RFID reader, and the first electronic coupler may be configured to communicate electric power to the second electronic coupler, to the weight sensor, and to the multi-protocol RFID reader. The devices of the system may function as a modular, intelligent, consumable liquid products shelf(s), designed to complement/co-exist with current or existing product (shelves, wells etc.) planograms, providing continuous real-time - inventory and consumable product statistics information. Preferably, the consumable product management system may include a plurality of consumable product management devices that may be positioned proximate to each other so that electronic communication may be established between the consumable product management devices via their electronic couplers and the system may enable ‘non-geographical boundaries’, e.g., devices may be both physically and virtually linked.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 shows a perspective view of an example of a consumable product management device according to various embodiments described herein.

FIG. 2 illustrates a sectional, through line 2-2 shown in FIG. 1, elevation view of an example of a consumable product management device according to various embodiments described herein.

FIG. 3 depicts a perspective view of two example bottom plates and example electronic couplers according to various embodiments described herein.

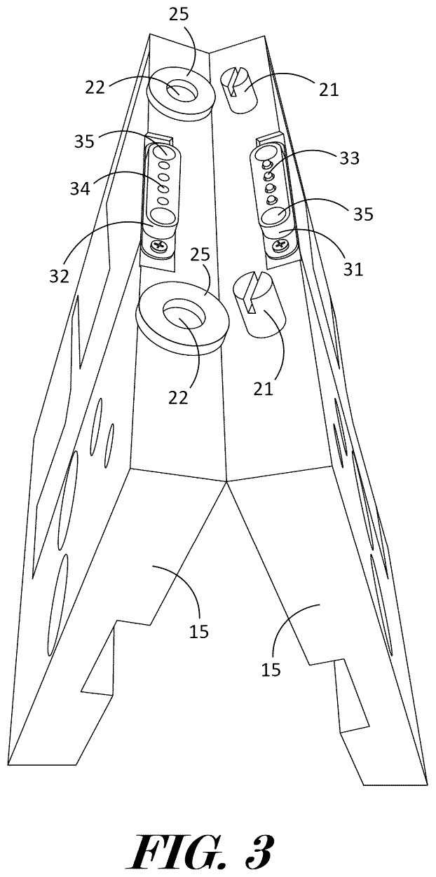

FIG. 4 illustrates a perspective view of another example of a consumable product management device according to various embodiments described herein.

FIG. 5 depicts a perspective, partial exploded view of a further example of a consumable product management device according to various embodiments described herein.

FIG. 6 shows a perspective view of a further example of a consumable product management device according to various embodiments described herein.

FIG. 7 illustrates a top perspective view of an example product plate according to various embodiments described herein.

FIG. 8 depicts a perspective view of an example of a consumable product management system having a plurality of consumable product management devices supporting consumable product containers over a support object according to various embodiments described herein.

FIG. 9 shows a partial, sectional, through line 9-9 shown in FIG. 8, elevation view of some example consumable product management devices of a consumable product management system according to various embodiments described herein.

FIG. 10 illustrates a perspective view of an example of a consumable product management device engaged to a standalone power source in use with an example support object according to various embodiments described herein.

FIG. 11 depicts a block diagram illustrating an example of a consumable product management device according to various embodiments described herein.

FIG. 12 shows a schematic diagram of an example of a consumable product management system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

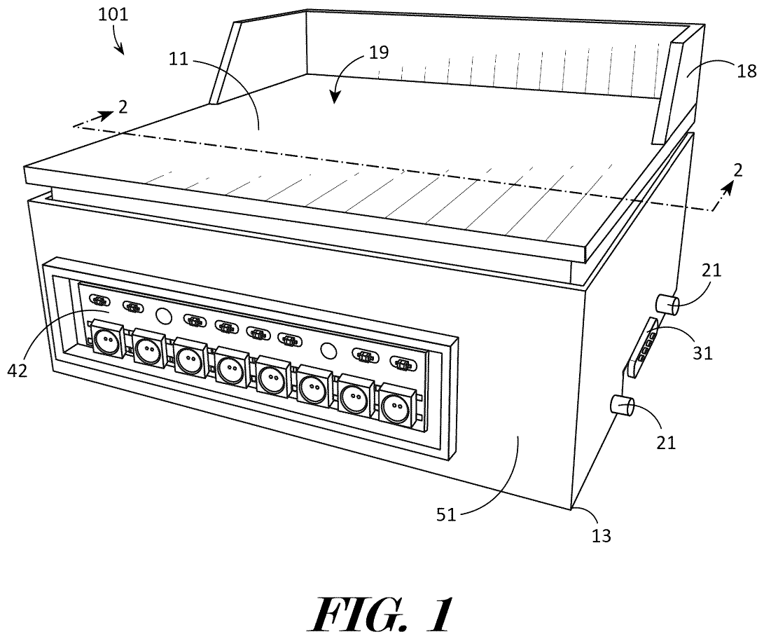

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer based on instructions received by computer software.

The term “client device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of client devices which are portable and easily carried by a person from one location to another may sometimes be referred to as a “portable client device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

As used herein the term “data network” or “network” shall mean an infrastructure capable of connecting two or more computers such as client devices either using wires or wirelessly allowing them to transmit and receive data. Non-limiting examples of data networks may include an internet, the internet or wireless networks or (i.e. a “wireless network”) which may include BLE (Bluetooth), LoRa and LoRaWAN, Wifi, and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new consumable product management system and consumable product management device are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

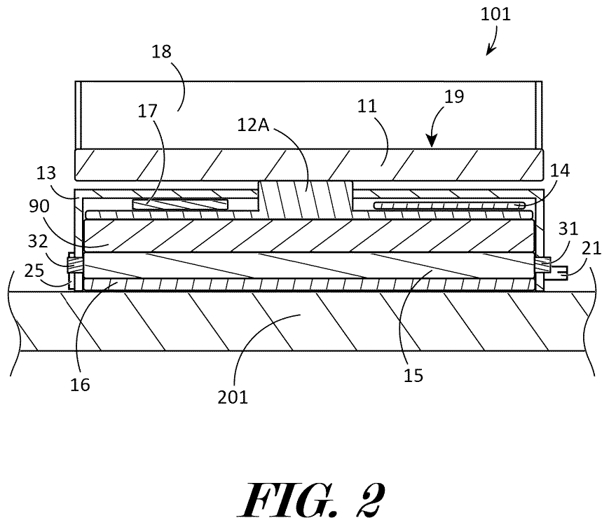

The present invention will now be described by example and through referencing the appended figures representing preferred and alternative embodiments. FIGS. 1, 2, 4-6, and 8-12 show examples of a consumable product management device (“the device”) 101 according to various embodiments described herein. In preferred embodiments, the system 100 may comprise at least one device 101, and the device 101 may comprise a product plate 11 having a product support surface 19. A weight sensor 12 may be coupled to the product plate 11, and the weight sensor 12 may be configured to generate weight data that describes the weight of a consumable product container 221 that is placed on the product support surface 19 of the product plate 11. The device 101 may include a multi-protocol RFID reader 17 that is configured to receive wireless electronic data describing the consumable product container 221 from a transponder 222 that is coupled to the consumable product container 221. A component cover 13 may be coupled to the product plate 11. A first electronic coupler 31 and a second electronic coupler 32 may be coupled to the component cover 13. The first electronic coupler 31 (and preferably the second electronic coupler 32) may be in electronic communication with the weight sensor 12 and the multi-protocol RFID reader 17, and the first electronic coupler 31 may be configured to communicate electric power to the second electronic coupler 32, to the weight sensor 12, and to the multi-protocol RFID reader 17. Preferably, the one or more devices 101 of the system 100 may function as a modular, intelligent, consumable liquid products shelf(s), designed to complement/co-exist with current or existing product (shelves, wells etc.) planogram, providing continuous real-time—inventory and consumable product statistics information.

A product plate 11 may be configured in any size and shape, such as a generally rectangular plate, and the product plate 11 may directly or indirectly support a consumable product container 221, such as liquor bottles, other beverage containers, etc., that is placed on the device 101. Optionally, a product plate 11 may be configured as a platform or shelf that a consumable product container 221 may be placed on. A product plate 11 may comprise a product support surface 19 that may form the surface that a consumable product container 221 may be placed on. A product plate 11 and its product support surface 19 may be configured in any shape and size. In some embodiments, a product plate 11 and its product support surface 19 may be sized and shaped to fit and support a liquor bottle and other beverage dispensing containers commonly used in bars, taverns, pubs, and other food and beverage vending businesses. In further embodiments, a product plate 11 and its product support surface 19 may be sized and shaped to fit and support a keg and other beverage dispensing containers commonly used in bar, taverns, pubs, and other food and beverage vending businesses, e.g., drums and barrels, IBC totes, and various types of bottles and jugs like growlers. In some embodiments, a product plate 11 and its product support surface 19 may be sized and shaped to fit and support any other type of container that is used to contain and/or dispense a product, including other edible products, such as dry goods, and non-edible products. Product plates 11 may be configured in a plurality of sizes and shapes to accommodate and support consumable product containers 221 that are formed in a plurality of sizes and shapes. For example, a product plate 11 may be configured with a size and shape that is larger than a bottom plate 15 so that larger (or unique shaped) products and containers 221 can be supported on it.

Preferably, a device 101 may comprise one or more retaining walls 18 which may be coupled to a product plate 11. Retaining walls 18 preferably may extend above the product plate 11 and product support surface 19. The one or more retaining walls 18 may guide placement and positioning of a consumable product container 221 on the product support surface 19 and/or prevent a consumable product container 221 from sliding or falling off the product support surface 19. Optionally, a retaining wall 18 may be fixed to a product plate 11 in a substantially non-removable manner. Optionally, a retaining wall 18 may be removably coupled to the product plate 11.

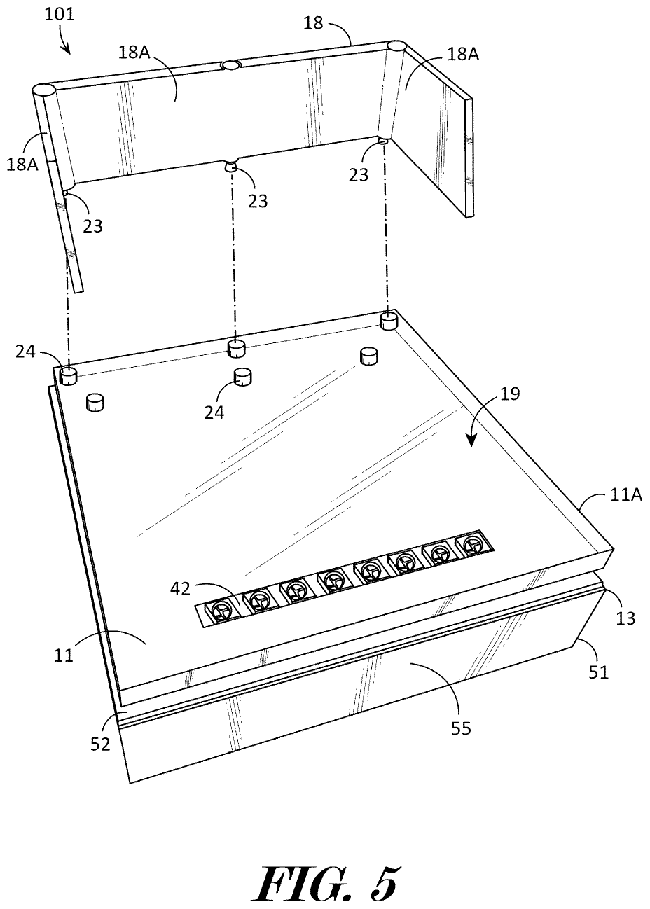

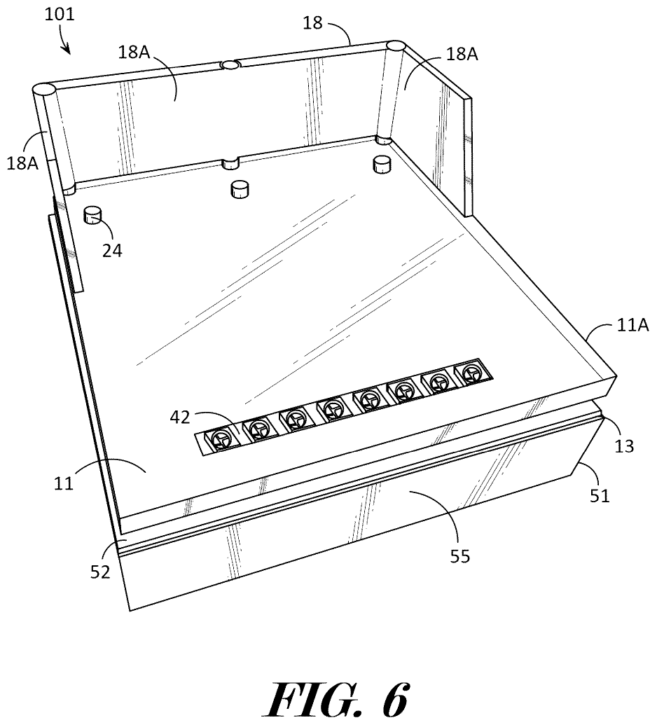

A retaining wall 18 may be configured in any size and shape. In preferred embodiments, a retaining wall 18 may comprise one or more, such as three, wall sections 18A which may extend above the product plate 11 and product support surface 19 when the retaining wall 18 is coupled to the product plate 11. For example, and as perhaps best shown in FIGS. 5 and 6, a retaining wall 18 may comprise three planar sections 18A which may form a three-sided wall that may extend around the majority of a perimeter of a consumable product container 221 that is placed on the product support surface 19.

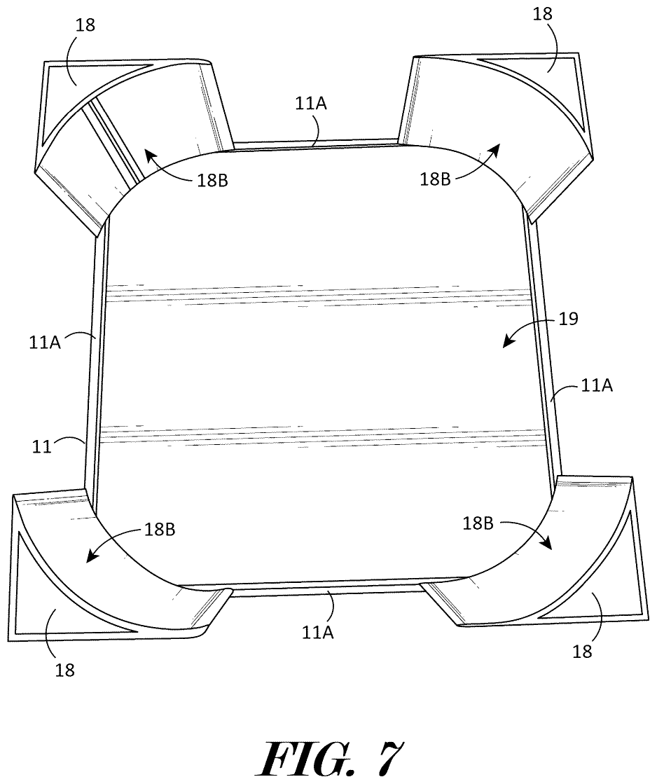

In some embodiments, and as perhaps best shown in FIG. 7, the device 101 may comprise a plurality, such as two or more, of retaining walls 18 which may be coupled to a product plate 11, and each retaining wall 18 may comprise a curved surface 18B. Each retaining wall 18 may be coupled to or proximate to the perimeter 11A of the product plate 11, and the curved surface 18B of each retaining wall 18 may be oriented away from the perimeter 11A. Preferably, the curved surfaces 18B may be convex curved away from the center of the product plate 11 so that a consumable product container 221 may fit on the product plate 11 between the retaining walls 18 and their curved surfaces 18B.

In some embodiments, one or more retaining walls 18 may be removably coupled to the product plate 11. In preferred embodiments, one or more retaining walls 18 may be repositionably coupled to the product plate 11 so that the one or more retaining walls 18 may be alternatively and removably coupled to different parts or locations on the product plate 11. For example, a retaining wall 18 may be removably coupled to a first position on the product plate 11 that is relatively closer to the perimeter 11A or farther from the center of the product plate 11, such as to accommodate relatively larger sized consumable product containers 221, and the retaining wall 18 may be removably coupled to a second position on the product plate 11 that is relatively farther from the perimeter 11A or closer to the center of the product plate 11, such as to accommodate relatively smaller sized consumable product containers 221. Any suitable removable coupling method or fastener may be used to repositionably couple a retaining wall 18 to the product plate 11. For example, the retaining wall 18 may comprise a plurality of studs 23 which may be frictionally fit into a plurality of apertures 24 formed in the product support surface 19.

The device 101 may comprise a weight sensor 12 which may be configured to provide weight data to the processing unit 90 that describes the weight of an object, such as a consumable product container 221, that is directly or indirectly placed on the product plate 11. Generally, the weight sensor 12 may determine the weight of a consumable product container 221, and therefore any consumable product that is contained in the consumable product container 221, that is placed on the product support surface 19 of the product plate 11. In some embodiments, a weight sensor 12 may be coupled to the bottom of the product plate 11 and to another element of the device 101, such as to a bottom plate 15. For example, a product plate 11 may be indirectly coupled to the component cover 13 by the product plate 11 being coupled to a weight sensor 12 that is coupled to a bottom plate 15 in which the bottom plate 15 is coupled to the component cover 13. As another example, a product plate 11 may be indirectly coupled to the component cover 13 by the product plate 11 being coupled to a weight sensor 12 that is coupled to the bottom plate 15.

In some embodiments, a weight sensor 12 may comprise a load cell 12A which may be transducer which converts a force or weight into a measurable electrical output that may be used as weight data of a consumable product container 221 placed on the product plate 11 that the load cell 12A is coupled to. Preferably, a load cell 12A may comprise a strain gauge load cell or any other type of device for measuring the weight of objects.

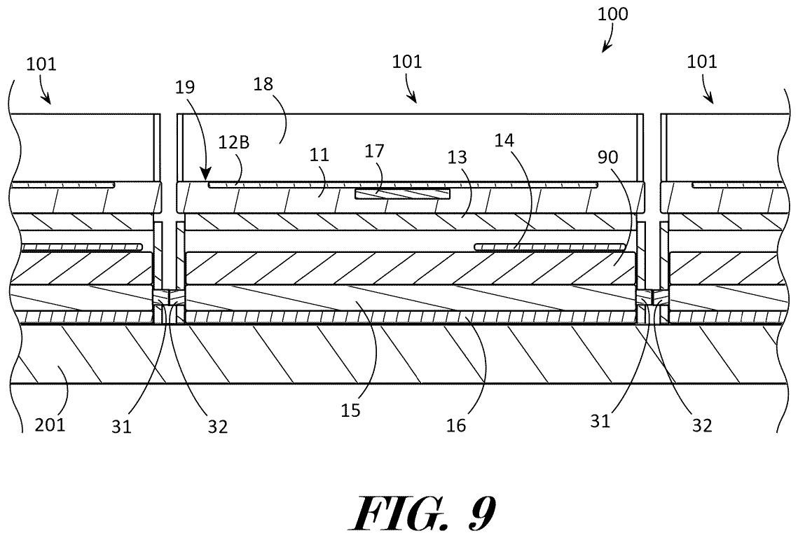

In some embodiments, a weight sensor 12 may comprise a force sensing resistor membrane 12B. A force sensing resistor membrane 12B, sometimes called a weight sensor resistive membrane, a Force Sensing Resistor (FSR), or a membrane load cell, is a thin, flexible sensor that changes its electrical resistance in proportion to the force or weight applied to its surface. The change in electrical resistance may be used to provide or generate weight data of a consumable product container 221 placed on the force sensing resistor membrane 12B. In preferred embodiments, the device 101 may comprise a force sensing resistor membrane 12B that may be coupled to product support surface 19. For example, a force sensing resistor membrane 12B may be coupled directly onto the product support surface 19. Preferably, a product plate 11 may comprise a depression in the product support surface 19 that the force sensing resistor membrane 12B may be coupled to so that the force sensing resistor membrane 12B may be recessed into the product support surface 19, as perhaps best shown in FIG. 9.

In some embodiments, the device 101 may comprise a network interface 14 that may be in electronic communication with one or more of a processing unit 90, a weight sensor 12, and a multi-protocol RFID reader 17. A network interface 14 may enable electronic communication of data, such as weight data and data describing the consumable product container 221 from a transponder 222 that is coupled to the consumable product container 221, between devices 101, between systems 100, between servers 300, and client devices 400, such as via wireless communication protocols and/or wired electronic communication that may be provided via electronic couplers 31, 32. Optionally, a network interface 14 may be integrated with a processing unit 90. In preferred embodiments, a network interface 14 may be configured to wirelessly and/or wiredly communicate weight data and data describing the consumable product container 221 to one or more devices 101, systems 100, servers 300, and client devices 400 preferably via a network connection 104.

In some embodiments, a network interface 14 may enable electronic communication between one or more of a processing unit 90, a weight sensor 12, and a multi-protocol RFID reader 17 of the device 101 and other electronic devices (e.g., client devices 400, servers 300, etc.). Optionally, a network interface 14 may enable wired communication to an external access device or network through one or more electronic couplers 31, 32, of the device 101. For example, a network interface 14 may operate to provide a wired connection using the RS485 wired communication protocol which is a serial communication standard that may be used for wired communication, including for sending data over long distances and connecting multiple devices on a single bus. Optionally, a network interface 14 may enable wireless communication to an external access device or network through an antenna.

Preferably, a network interface 14 may comprise a wireless communication receiver and optionally a wireless communication transmitter. In some embodiments, a network interface 14 may utilize one or more wireless network protocols based on the IEEE 802.11 family of standards (e.g., Wi-Fi), which are commonly used for local area networking of devices and Internet access, allowing nearby digital devices to exchange data by radio waves. Any number of suitable wireless data communication protocols, techniques, or methodologies can be supported by the network interface 14, including, without limitation: RF; IrDA (infrared); Bluetooth; LoRa and LoRaWAN, ZigBee (and other variants of the IEEE 802.15 protocol); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

In some embodiments, the device 101 may comprise a multi-protocol radio frequency identification (RFID) reader 17, and the multi-protocol RFID reader 17 may receive wireless electronic data describing a consumable product container 221 that is placed on the product plate 11 from a transponder 222 that may be coupled to the consumable product container 221. For example, the multi-protocol RFID reader 17 may comprise a radio frequency identification (RFID) reader or interrogator and a transponder 222 may comprise a RFID tag, NFC tag, etc., that has data describing the consumable product container 221, such as the volume of the consumable product container 221, the name of the consumable product contained in the product container 221, the density of the consumable product contained in the product container 221, etc. In further embodiments, a multi-protocol RFID reader 17 may comprise any other device or method for wirelessly obtaining data describing a consumable product container 221 placed directly or indirectly on the product plate 11.

In preferred embodiments, a multi-protocol RFID reader 17 may comprise a Near Field Communication (NFC) and Radio Frequency Identification (RFID) reader so that the multi-protocol RFID reader 17 may be able to operate and receive data describing a consumable product container 221 using one or more of Near Field Communication (NFC) protocols and Radio Frequency Identification (RFID) protocols.

A multi-protocol RFID reader 17 may be coupled to any element of a device 101. In some embodiments, a multi-protocol RFID reader 17 may be coupled to a bottom plate 15. In some embodiments, a multi-protocol RFID reader 17 may be integrated with a processing unit 90. In further embodiments, and as shown in FIG. 9, a multi-protocol RFID reader 17 may be coupled to the product plate 11, such as by being coupled within a recess or depression formed in the product plate 11, by being integrally formed or molded into the product plate 11, etc. Optionally, a force sensing resistor membrane 12B and a multi-protocol RFID reader 17 may be integrally formed together.

In some embodiments, the device 101 may comprise a bottom plate 15 that may be coupled to a component cover 13 so that the bottom plate 15 and component cover 13 may form a housing for one or more electronic components, e.g., a weight sensor 12 such as a load cell 12A, network interface 14, processing unit 90, etc., of the device 101. Preferably, a component cover 13 may be placed on and be coupled to the bottom plate 15 in a ‘top down’ configuration for added sealing from product leakage. Preferably, a product plate 11 may mount directly to a weight sensor 12 that may be a load cell 12A to decrease the height of the device 101. A bottom plate 15 may be configured in any size and shape, such as a rectangular prism shape and may be made from plastic or other structural material. Optionally, the bottom plate 15 may comprise base shielding 16 which may be positioned between the bottom plate 15 and a support object 201 that the device 101 is resting on. As an example, base shielding 16 may comprise a sheet of copper which may electrically shield the electronic components of the device 101 from the support object 201 that the device 101 is placed on.

A component cover 13 may be configured in any size and shape, such as a rectangular prism shape. In preferred embodiments, a component cover 13 may comprise a front wall 51, a top wall 52, and one or more sidewalls 53. Generally, a front wall 51 may face towards an area that is occupied by people so as to be easily observed by people proximate to the device 101, and a top wall 52 may be positioned above the front wall 51 so that the top wall 52 is below the product plate 11. Sidewalls 53 may be coupled to one or more of the front wall 51 and top wall 52 and may box in or wall in the component cover 13.

In some embodiments, a component cover 13 may comprise one or more walls 51, 52, 53, that may have a magnetic material 55. For example, a component cover 13 may comprise a front wall 51 having a magnetic material 55 that is coupled to the front wall 51. The magnetic material 55 may be coupled to the front wall 51 or other wall 52, 53, by being integrally formed or molded together, by the front wall 51 or other wall 52, 53, being made of a magnetic material 55, via adhesive, fasteners, or any other suitable coupling method. Preferably, the magnetic material 55 may allow signs, logos, prices, or other signage to be magnetically coupled to the component cover 13. In some embodiments, one or more walls 51, 52, 53, may comprise a magnetic material 55 that may be a magnetic ‘dry marker’ (erasable) material so that the magnetic material 55 may be used with ‘dry erase’ markers and other temporary writing utensils.

One or more electronic couplers 31, 32, may be coupled to the component cover 13, optionally by being coupled to a bottom plate 15 that is coupled to the component cover 13, and the electronic coupler 31, 32, may enable electronic communication, such as power communication and data communication, with the electronic coupler 31, 32, of a second device 101 that is positioned adjacent to the first device 101. In preferred embodiments, the device 101 may comprise two electronic couplers 31, 32, that may be coupled to opposing sides of the component cover 13 (optionally by being coupled to opposing sides of a bottom plate 15, so that an array of devices 101 may be formed by placing the devices 101 in line and adjacent to each other so that their electronic couplers 31, 32, are in contact with one or two devices 101. Optionally, the electronic communication enabled by the electronic coupler 31, 32, may comprise electronic power so that power may be communicated from one device 101 to another device 101 when the electronic coupler 31, 32, of the devices 101 are engaged together. Optionally, the electronic communication enabled by the electronic coupler 31, 32, may comprise electronic data transmission so that electronic data (such as weight data, data that describes a weight of a consumable product container 221, data that describes a consumable product container 221, etc.) one or more may be communicated from one device 101 to another device 101 when the electronic coupler 31, 32, of the devices 101 are engaged together.

In some embodiments, the system 100 may comprise a first device 101 and a second device 101. The first device 101 may have a first electronic coupler 31 coupled to a component cover 13 and a second electronic coupler 32 coupled to the component cover 13, and the first electronic coupler 31 and the second electronic coupler 32 may each be in electronic communication with a weight sensor 12 and a multi-protocol RFID reader 17 of the first device 101. The first electronic coupler 31 may be configured to communicate electric power to the second electronic coupler 32, to the weight sensor 12, and to the multi-protocol RFID reader 17. In further embodiments, the second device 101 may comprise one or more electronic couplers 31, 32, and the first electronic coupler 31 may be configured to receive electric power from an electronic coupler 31, 32, of the second device 101 when the first electronic coupler 31 is in contact with the electronic coupler 31, 32, of the second device 101. In further embodiments, the first electronic coupler 31 may be configured to communicate weight data from the weight sensor 12 of the first device 101 and/or data describing a consumable product container 221 placed on the product plate 11 of the first device 101 to the electronic coupler 31, 32, of the second device 101 when the first electronic coupler 31 is in contact with the electronic coupler 31, 32, of the second device 101.

In some embodiments, an electronic coupler 31, 32, may comprise one or more, such as four, pins 33 and/or one or more, such as four, contacts 34 which may enable electronic communication between adjacent and contacting electronic coupler 31, 32. Generally, pins 33 and contacts 34 may form electrical contacts and connections. Preferably, pins 33 may protrude away from the electronic coupler 31, 32, a greater distance than contacts 34, but pins 33 and contacts 34 may be configured in any size and shape.

In some embodiments, an electronic coupler 31, 32, may comprise one or more, such as two, magnetic couplers 35 which may be configured to engage the magnetic couplers 35 of an adjacent electronic coupler 31, 32, to maintain contact between the pins 33 and contacts 34 of two adjacent electronic couplers 31, 32. Magnetic couplers 35 may comprise neodymium magnets or any other magnetic material. In some embodiments, the system 100 may comprise a first device 101 and a second device 101. The first device 101 may have a first electronic coupler 31 and a second electronic coupler 32 that may each be in electronic communication with a weight sensor 12 and a multi-protocol RFID reader 17 of the first device 101. The first electronic coupler 31 of the first device 101 may comprise a first magnetic coupler 35 and an electronic coupler 31, 32, of the second device 101 may comprise a second magnetic coupler 35, and the first magnetic coupler 35 and the second magnetic coupler 35 may be magnetically coupled together when the first electronic coupler 31 of the first device 101 and the electronic coupler 31, 32, of the second device 101 are in contact with each other. In further embodiments, each electronic coupler 31, 32, may comprise two magnetic couplers 35, with the two magnetic couplers 35 having opposite polarity, so that the magnetic couplers 35 of two electronic couplers 31, 32, that are intended to be coupled together may be prevented from being inadvertently flipped as the polarity of the magnetic couplers 35 will prevent the electronic couplers 31, 32, from being connected if the electronic couplers 31, 32, are not correctly aligned.

In further embodiments, magnetic couplers 35 may comprise a magnetic material, such as ferrite, ferromagnetic metal, ferric oxide, manganese-zinc ferrite, nickel-zinc ferrite, strontium ferrite, cobalt ferrite, barium ferrite, alnico, iron-silicon magnet alloy, ferritic steel and ferritic stainless steel, Chromium-Cobalt-Iron alloy, iron-cobalt alloy, Silver-Manganese-Aluminium alloy, manganese bismuthide alloy, platinum-cobalt alloy, chromium-manganese antimonide alloy, sintered barium ferrite, oxide-coated iron-cobalt particles, nickel-iron alloy, samarium-cobalt alloy, cesium-cobalt alloy, and neodymium-iron-boron alloy.

In some embodiments, the device 101 may comprise one or more, such as two, posts 21, and one or more, such as two, post channels 22. Generally, posts 21 may comprise a cylinder or other shaped protrusion, and post channels 22 may comprise a cylindrical channel or other shaped depression into which a post 21 may be inserted into and frictionally retained within. Preferably, a post channel 22 may be formed in a guide insert 25 which may be a rubber, silicone, or other frictional material having an annular shaped cushion that surround the post channel 22. For example, a post 21 may comprise a metal cylinder and a post channel 22 may comprise a rubber, silicone or other frictional material having a cylindrical channel that the post 21 may be inserted into. Posts 21 and post channels 22 of two adjacent devices 101 may be mated together to help align and maintain contact between the pins 33 and contacts 34 of the electronic couplers 31, 32, of the two adjacent devices 101.

In preferred embodiments, a system 100 may comprise a first device 101 and a second device 101. When an electronic coupler 31, 32, of the first device 101 is placed in contact with an electronic coupler 31, 32, of the second device 101, a post 21 of the first device 101 may be mated or inserted into a post channel 22 of the second device 101 and/or a post 21 of the second device 101 may be mated or inserted into a post channel 22 of the first device 101. The posts 21 along with the post channels 22 and guide inserts 25 may provide: (a) guidance/irection for assembling, (b) make it physically ‘challenging’ to force incorrect assembly, (c) some limited protection for the connector pins, and the mating of the posts 21 of one device 101 with the post channels 22 of another device 101 or expansion coupler provides the ‘building block’ type physical construction between devices 101 having their electronic couplers 31, 32, in contact. Optionally, the system 100 may comprise one or more expansion couplers of various sizes and shapes which allow electronic connecting of the electronic couplers 31, 32, of two or more adjacent devices 101 in an angular fashion or other non-linear fashion (for example to electronically connect the electronic couplers 31, 32, of adjacent devices 101 that are placed on a corner shelf or slightly curved shelf).

In some embodiments, the device 101 may comprise one or more, such as a plurality of, display devices 42 which may be configured to visually output or display information to a user. Preferably, a display device 42 may be configured to illuminate in various colors and intensities of light, and/or may be configured to visually output words, phrases, graphics, logos, etc. In some embodiments, a display device 42 may comprise a light emitting device such as a light-emitting diode (LED). In further embodiments, a display device 42 may comprise a Liquid crystal display (LCD), Light-emitting diode display (LED), Electroluminescent display (ELD), Electronic paper, E Ink, E-Paper display, Plasma display panel (PDP), Cathode ray tube display (CRT), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), and/or any other device or method which may be configured to provide visual information to a user and optionally to receive input from a user such as a touch screen display. As an example, a display device 42 may enable the device 101 to visually display status and promotional opportunities, optionally comprising an eight position, 256 color addressable display.

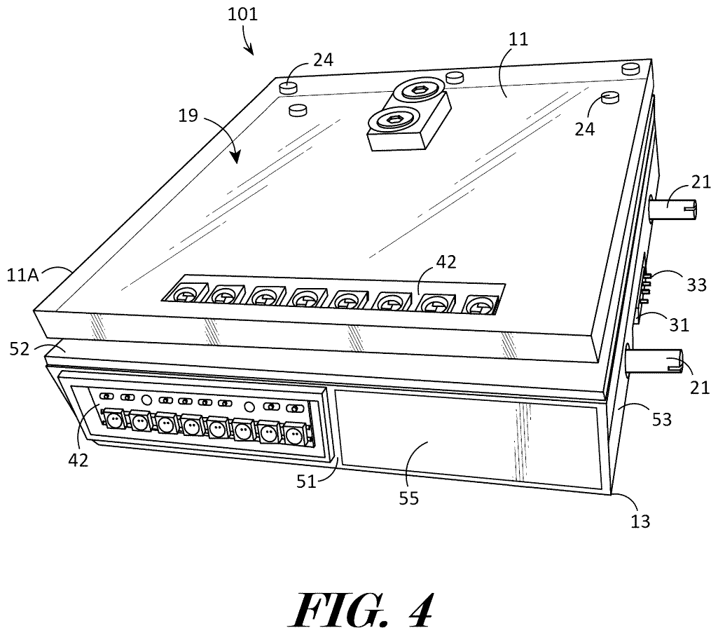

In some embodiments, and as perhaps best shown in FIGS. 1 and 4, a device 101 may comprise a display device 42 coupled to a front wall 51 of the component cover 13. Preferably, the front wall 51 of the component cover 13 may face towards an area that is occupied by people so that the display device 42 coupled to the front wall 51 may be easily observed by people proximate to the device 101.

In some embodiments, and as perhaps best shown in FIGS. 4-6 , a device 101 may comprise a display device 42 coupled to a top wall 52 of the component cover 13 so that the display device 42 is positioned below the product plate 11. Preferably, the top wall 52 of the component cover 13 may be positioned above the front wall 51 so that the top wall 52 is below the product plate 11. In further embodiments, and as perhaps best shown in FIGS. 4-6 , the device 101 may include a product plate 11 that comprises a translucent material that is positioned above the display device 42 coupled to the top wall 52 so that the display device 42 is configured to illuminate the translucent material. As used herein, a translucent material may allow light to pass through it and may include transparent materials and translucent materials. Transparent materials allow nearly all light to pass through, letting an observer see objects clearly on the other side, while translucent materials allow some light to pass through, but it is scattered, so objects on the other side appear blurry or indistinct. Example materials which may be substantially transparent or translucent include plastics such as polycarbonate, acrylic or polyacrylate made from Methyl Methacrylate (MMA), Poly Methyl Methacrylate, a combination of both, polystyrene, and glass.

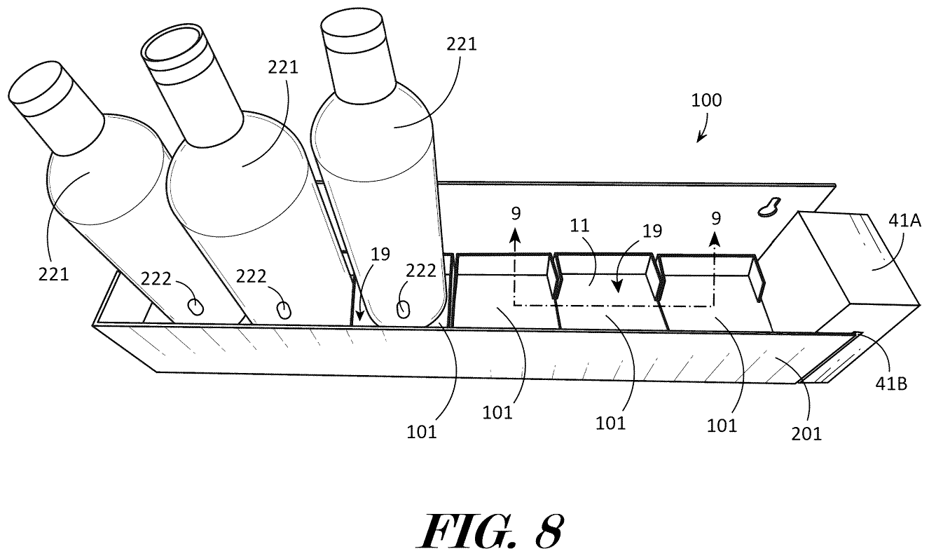

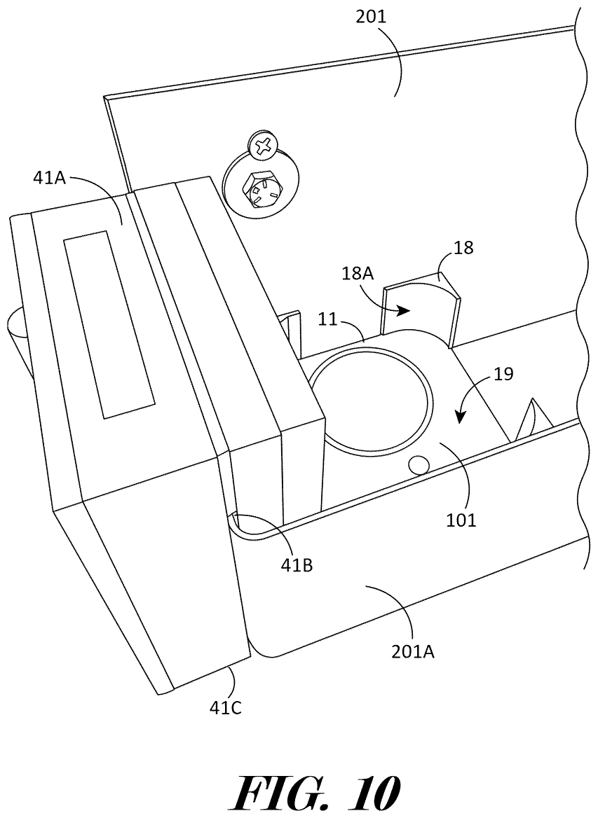

In some embodiments, the device 101 may comprise a power source 41 which may provide electrical power to any component that may require electrical power. In further embodiments, the system 100 may comprise a power source 41 that may provide electric power to one or more devices 101 of the system 100, preferably through the electronic couplers 31, 32, of the devices 101. For example, the system 100 may comprise a power source 41 that may be configured as an external or standalone power source 41A (FIGS. 8 and 10) and that may supply power to one or more devices 101. The standalone power source 41A may comprise one or more electronic couplers 31, 32, such as used in devices 101, that at least one device 101 of a series of devices 101 may be connected to via an electronic coupler 31, 32, of a first device 101 and the electric power may be communicated to the other devices 101 through their interconnected electronic couplers 31, 32. In some embodiments, a standalone power source 41A may comprise a housing 41C, and a channel 41B may be formed in the housing 41C. The channel 41B may fit over a portion of a vertical wall 201A of a speed well type of support object 201 so that a portion of the standalone power source 41A may fit in the speed well type of support object 201 and contact a device 101 in the speed well type of support object 201. The standalone power source 41A may comprise an electrical connector such as an electronic coupler 31, 32, that may contact the electronic coupler 31, 32, of the device 101 to enable the standalone power source 41A to provide electronic power to the device 101 and to any other device 101 that may be electronically connected to the device 101 via an electronic coupler 31, 32, e.g., the standalone power source 41A may provide electric power to a series of devices 101 via the connection provided by the electronic couplers 31, 32, of the devices 101. A speed well (or speed rail/rack) in a bar is a strategically placed, easily accessible shelf or compartment, usually right in front of the bartender, holding the bar's most popular, lower-cost “house” liquors (vodka, gin, rum, tequila, whiskey) for making quick, basic mixed drinks (well drinks) efficiently and rapidly.

A power source 41 may comprise a battery, such as a lithium-ion battery, nickel cadmium battery, alkaline battery, or any other suitable type of battery, a fuel cell, a capacitor, a super capacitor, or any other type of electricity storing and/or releasing device. In further embodiments, a power source 41 may comprise a power cord, kinetic or piezo electric battery charging device, a solar cell or photovoltaic cell, and/or inductive charging or wireless power receiver. In further embodiments, a power source 41 may comprise a power charging and distribution module which may be configured to control the recharging of the power source 41, discharging of the power source 41, and/or distribution of power to one or more components of the device 101 that may require electrical power. As an example, the device 101 may comprise a removable expansion pod module that may be removably coupled to the component cover 13 and/or bottom plate 15, and the expansion pod module may comprise power source 41 having a rechargeable battery and inductive charging or wireless power receiver. The device 101 may also include a pod charging deck having a wireless power transmitter that may wirelessly transmit power to the power source 41 and that may be supplied electronic power via an end communications and power connector.

In some embodiments, the device 101 may comprise a product plate 11 which may be coupled to a load cell 12A. The load cell 12A may be coupled to a bottom plate 15, and the component cover 13 may support the device 101 above a support object 201, such as an existing shelf. Preferably, only the product plate 11, its product support surface 19, and retaining wall 18 may be coupled to the load cell 12A, and these elements 11, 18, 19, may comprise the ‘free moving surface’ on which a consumable product container 221 may be placed to reference (weigh). A network interface 14 and the load cell 12A may be in electronic communication with a processing unit 90. A bottom plate 15 may be coupled to the component cover 13. Optionally, the bottom plate 15 may comprise base shielding 16 which may be positioned between the bottom plate 15 and a support object 201 that the device 101 is resting on. The load cell 12A may provide signals to the processing unit 90 which may be used to determine the weight of a consumable product container 221 that is placed on the product plate 11, and the network interface 14 may receive wireless electronic data describing the consumable product container 221 from a transponder that may be coupled to the consumable product container 221. An electronic coupler 31, 32, may be coupled to the bottom plate 15, and the electronic coupler 31, 32, may enable electronic communication with the processing unit 90, and provide an interconnection to subsequent bottom plates 15 of one or more devices 101 that are positioned adjacent to the first device 101.

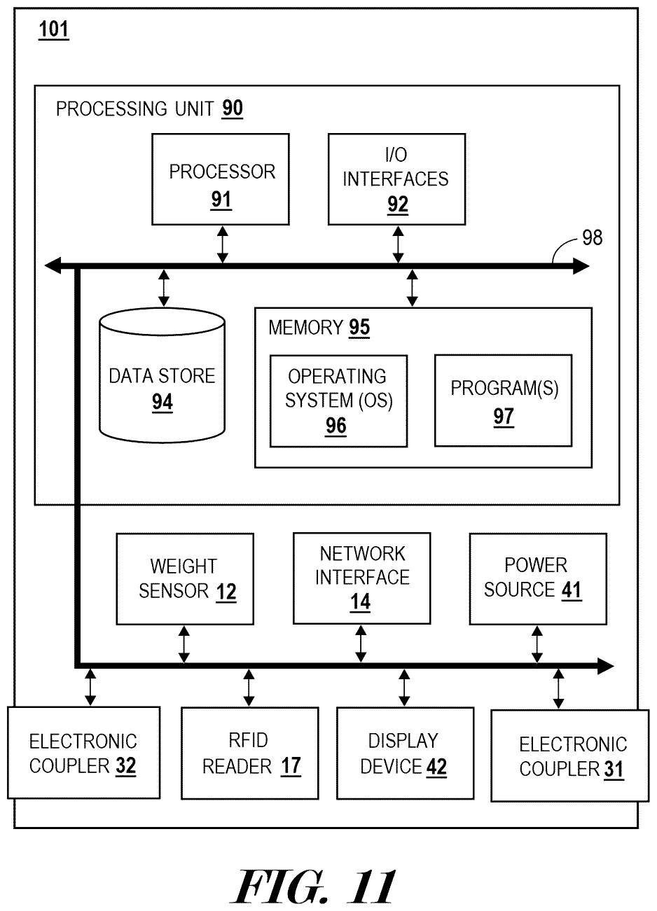

FIG. 11 depicts a block diagram of an example of a consumable product management device 101 according to various embodiments described herein. In some embodiments, the device 101 may be a digital device that, in terms of hardware architecture, may optionally comprise a processing unit 90 that may be in electronic communication with one or more of the weight sensor 12, network interface 14, multi-protocol RFID reader 17, display device 42, power source 41, and electronic coupler 31, 32. It should be appreciated by those of ordinary skill in the art that FIG. 11 depicts an example of the device 101 in an oversimplified manner, and a practical embodiment may include additional components or elements and suitably configured processing logic to support known or conventional operating features that are not described in detail herein.

The components and elements of the device 101 may be communicatively coupled via a local interface 98. The local interface 98 can be, for example but not limited to, one or more buses or other wired or wireless connections, as is known in the art. The local interface 98 can have additional elements, which are omitted for simplicity, such as controllers, buffers (caches), drivers, repeaters, and receivers, among many others, to enable communications. Further, the local interface 98 may include address, control, and/or data connections to enable appropriate communications among the aforementioned components.

In some embodiments, a processing unit 90 may comprise one or more processors 91, I/O interfaces 92, data stores 94, and/or memory 95. The processor 91 is a hardware device for executing software instructions. The processor 91 can be any custom made or commercially available processor, a central processing unit (CPU), an auxiliary processor among several processors, a semiconductor-based microprocessor (in the form of a microchip or chip set), or generally any device for executing software instructions. When in operation, the processor 91 is configured to execute software stored within the memory 95, to communicate data to and from the memory 95, and to generally control operations of the device 101 pursuant to the software instructions. In an exemplary embodiment, the processor 91 may include a mobile optimized processor such as optimized for power consumption and mobile applications.

Optionally, the device 101 may optionally include one or more I/O interfaces 92 can be used to input and/or output information and power. In some embodiments, I/O interfaces 92 may include one or more turnable control knobs, depressible button type switches, a key pad, slide type switches, dip switches, rocker type switches, rotary dial switches, numeric input switches or any other suitable input which a user may interact with to provide input. In some embodiments, the device 101 may include a magnetic reed switch. In some embodiments, the multi-protocol RFID reader 17 may be or may comprise an I/O interface 92 (aside from reading ‘products’—it may also allow for operational ‘function selection’). In further embodiments, I/O interfaces 92 may include one or more light emitting elements or other display device, e.g., a LED (light emitting diodes), a speaker, or any other suitable device for outputting or displaying information. The I/O interfaces 92 can also include, for example, a serial port, a parallel port, a small computer system interface (SCSI), an infrared (IR) interface, a radio frequency (RF) interface, a universal serial bus (USB) interface, and the like.

A data store 94 may be used to store data. The data store 94 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 94 may incorporate electronic, magnetic, optical, and/or other types of storage media.

A memory 95 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 95 may incorporate electronic, magnetic, optical, and/or other types of storage media. Note that the memory 95 may have a distributed architecture, where various components are situated remotely from one another, but can be accessed by the processor 91. The software in memory 95 can include one or more software programs, each of which includes an ordered listing of executable instructions for implementing logical functions. In the example of FIG. 10, the software in the memory system 95 may include a suitable operating system (O/S) 96 and programs 97. An operating system 96 essentially controls the execution of input/output interface 92 functions, and provides scheduling, input-output control, file and data management, memory management, and communication control and related services. The operating system 96 may be, for example, LINUX (or another UNIX variant) and any Linux-kernel-based operating systems, Raspbian, Ubuntu, OpenELEC, RISC OS, Arch Linux ARM, OSMC (formerly Raspbmc) and the Kodi open source digital media center, Pidora (Fedora Remix), Puppy Linux, combination of the GNU system and the Linux kernel (GNU/Linux), Android (available from Google), Symbian OS, Microsoft Windows 10, 11, etc., Microsoft Windows 11 Mobile, iOS (available from Apple, Inc.), webOS (available from Hewlett Packard), Blackberry OS (Available from Research in Motion), and the like. The programs 97 may include various applications, add-ons, etc. configured to provide end user functionality such as to control the operation of functions of the device 101.

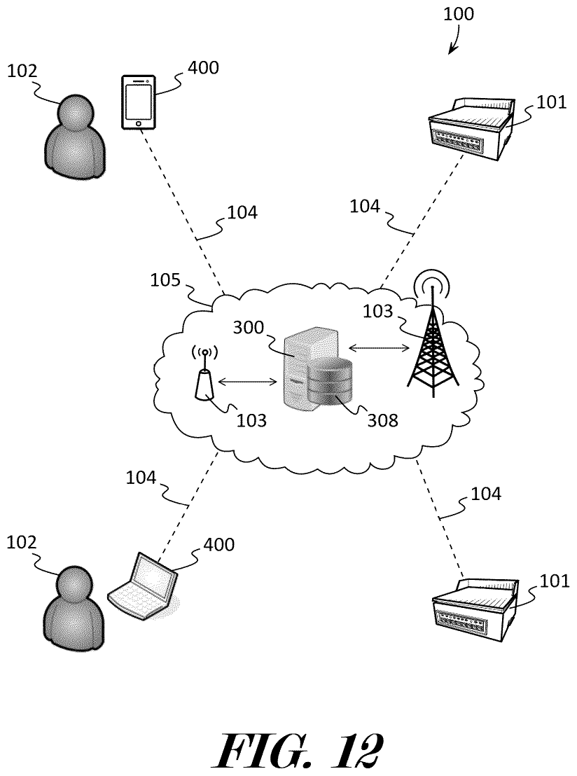

Referring to FIGS. 11 and 12, in some embodiments, the network interface 14 may enable the device 101 to communicate data to and from one or more access points 103, gateways, servers 300 and client devices 400 via a wired and/or wireless network connection 104 enabled by the network interface 14. In preferred embodiments, the system 100 may be configured to communicate data, including weight data and data describing the consumable product container 221 from the one or more devices 101, to and from a client device 400 that may be operated by a user 102 of the device 101. Client devices 400 may include mobile devices, such as laptops, tablet computers, personal digital assistants, smart phones, and the like, that are equipped with a wireless network interface capable of sending data to one or more servers 300 with access to one or more data stores 308 over a network 105, such as a wireless local area network (WLAN). Additionally, client devices 400 may include fixed devices, such as desktops, workstations, and the like, that are equipped with a wireless or wired network interface capable of sending data to one or more servers 300 with access to one or more data stores 308 over a wireless or wired local area network 105.

One or more of the devices 101 of a system 100 may be in wired and/or wireless communication with one or more of one or more other devices 101, a wireless network 105, a wired network, e.g., a local intranet, a server 300, and a client device 400. In some embodiments, a system 100 may comprise a device 101 that may be connected to a network 105 in an extension to location configuration, in which the device 101 comprises a wireless network interface 14 that may be connected to wireless gateway 103/internet that is in turn connected to an Off site server 300. In some embodiments, a system 100 may comprise a device 101 that may be connected to a network 105 in a Centralized (Concentrator) configuration in which the device 101 comprises a data port, such as a wired network interface 14, and the data port may be connected to wireless module gateway 103/internet that is in turn connected to Off site server 300. In some embodiments, a system 100 may comprise a device 101 that may be connected to a network 105 in a Distributed (Gateway) configuration in which the device 101 comprises a data port, such as a wired network interface 14, and the data port may be connected to wireless module gateway 103/internet that is in turn connected to an ON site server 300. In some embodiments, a system 100 may comprise a device 101 that may be connected to a network 105 in a Hybrid (Combinations) configuration in which the device 101 comprises a wireless and/or wired network interface 14 and the network interface 14 may be in electronic communication with an Off site server 300 and/or an ON site server 300. Although a network connection 104 may be initially required by one or more devices 101 of the system 100, once operational, the devices 101 preferably may utilize one or more of the above-mentioned network connectivity options to operate autonomously from a centralized server 300, re-syncing data when the connection is resumed.

FIG. 12 depicts an example of a consumable product management system (“the system”) 100 according to various embodiments described herein. In some embodiments, a system 100 may comprise one or more devices 101 that may be in communication with a server 300 and/or client devices 400 via a network connection 104. In preferred embodiments, a system 100 may comprise two or more devices 101 that may be placed proximate to each other and which may be in electronic communication with each other via engaging their electronic coupler 31, 32, together. The system 100 may comprise any number of devices 101, in which the number of devices 101 and which devices are connected together via their electronic couplers 31, 32, to at least one other device 101 is determined by the planogram requirements of a particular location that the system 100 is installed at, (e.g., the length and size of a shelf or surface that the devices 101 are to be positioned on). Preferably, the devices 101 of the system 100 may function as a modular, intelligent, consumable liquid products shelf(s), designed to complement/co-exist with current or existing product (shelves, wells etc.) planogram, providing continuous real-time—inventory and consumable product statistics information. The devices 101 of the system 100, once positioned proximate to each other and electronically connected by engaging their electronic couplers 31, 32, to at least one other device 101 may to create a physical shelf, each device 101 supporting a consumable product container 221, and a virtual shelf, each device 101 generating data describing the consumption of the consumable product in the consumable product container 221 it is supporting and by optionally outputting data to individuals proximate to the device 101 via a display device 42 and/or speaker type of I/O interface 92. By installing the system 100 having a plurality of devices 101 that function as intelligent modular ‘plates’a business owner or operator is provided with real-time data of the consumable product in the consumable product container 221 supported by each device 101 enabling a global, comprehensive view of every inventoried product. This ‘view’ includes the physical movement, consumption, marketing enablement, instantaneous visual and reporting statistics, and most important end-of-day reconcile within seconds of ‘closing’, whilst at the same time allow for hierarchical levels of product management and consumption visibility (ex. manager, owner, distributor, manufacturer, etc.) which enables the system 100 and devices 101 to provide ‘consumption data’with no physical and/or geographical boundaries.

In some embodiments, a system 100 having a plurality of devices 101 that are positioned proximate to each other and electronically connected together may function as an intelligent shelf ‘assembly block’ for supporting a plurality of consumable product containers 221 on the plurality of devices 101. The physical connecting of ‘n’ blocks may be used to build (create) an intelligent physical shelf either on-top-of an existing support object 201, or a new ‘solid shelf’. The implementation of these ‘shelves’upon/in existing (or new) consumable products to provide product movement and consumption data of the individual consumable products contained in the consumable product containers 221 that are supported by the devices 101. This enables the system 100 to have the ability to ‘build’ physical shelf configurations, within physical locations using Intelligent Modular Plates (devices 101), enabling the creation of virtual-shelf ‘planograms’ within a given customer's footprint, with no geographical boundaries. In preferred embodiments of the system 100, one or more, such as each device 101 may have the ability to visually display status information and promotional opportunities via a display device 42 on the one or more devices 101, e.g., an 8 position, 256 color addressable display. In further embodiments of the system 100, one or more, such as each device 101 may have the ability to generate audio status information and promotional opportunities via a speaker type of I/O interface 92 on the one or more devices 101. In further embodiments of the system 100, one or more, such as each device 101 may have the ability to attach to pods for remote, wireless, battery-operated applications.

In some embodiments, the system 100 may comprise one or more devices 101 that are configured to support consumable product containers 221, and the system 100 may associate a support consumable product container 221 to a specific device 101 virtually. For example, product association may be ‘virtual’, as support consumable product containers 221 or products can move between devices 101 anywhere within the system 100, and they will be managed accordingly as to their consumption status and levels.

In some embodiments, the system 100 may comprise one or more devices 101 that are configured to support consumable product containers 221, and the system 100 may provide continuous real-time - inventory and consumable product statistics information. The continuous real-time - inventory and consumable product statistics information enables the system 100 to provide an ‘open’/‘close’, or ‘take a snapshot’ so that business operations consumption levels of consumable products contained in the consumable product containers 221 may be output by the system 100 instantaneously.

In some embodiments, with the exception of cataloging (i.e. receiving into inventory) products, once implemented, the one or more devices 101 of the system 100 operate transparently to standard business operations, maintaining (an/or increasing) operations productivity.

In some embodiments, the system 100 may comprise one or more devices 101 that enable customized consumption messaging to be displayed on display device(s) 42 of the devices 101 in which the customized consumption messaging corresponds to a specific consumable product contained in consumable product containers 221, e.g., consumable product is on-special, consumable product is new-product, 2-for-1 pricing of the consumable product, to highlight the existence (or absence) of allergens (e.g. Dairy, nuts) of the consumable product when requested.

While some materials have been provided, in other embodiments, the elements that comprise the device 101, such as the product plate 11, component cover 13, bottom plate 15, and/or any other element discussed herein may be made from durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 101 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 101 may be coupled or removably connected by being press fit or snap fit together, by one or more fasteners such as, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 101 may be coupled by being one of connected to and integrally formed with another element of the device 101.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A consumable product management system, the system comprising a first consumable product management device, the first consumable product management device comprising:
a product plate having a product support surface;
a weight sensor coupled to the product plate, wherein the weight sensor is configured to generate weight data that describes a weight of a consumable product container that is placed on the product support surface;
a multi-protocol RFID reader that is configured to receive wireless electronic data describing the consumable product container from a transponder that is coupled to the consumable product container;
a component cover coupled to the product plate; and
a first electronic coupler coupled to the component cover and a second electronic coupler coupled to the component cover, wherein the first electronic coupler and the second electronic coupler are each in electronic communication with the weight sensor and the multi-protocol RFID reader, and wherein the first electronic coupler is configured to communicate electric power to the second electronic coupler, to the weight sensor, and to the multi-protocol RFID reader.

2. The system of claim 1, further comprising a second consumable product management device, wherein the second consumable product management device comprises a third electronic coupler, and wherein the first electronic coupler is configured to receive electric power from the third electronic coupler of the second consumable product management device when the first electronic coupler and the third electronic coupler are in contact with each other.

3. The system of claim 1, further comprising a second consumable product management device, wherein the second consumable product management device comprises a third electronic coupler, and wherein the first electronic coupler is configured to communicate the weight data to the third electronic coupler of the second consumable product management device when the first electronic coupler and the third electronic coupler are in contact with each other.

4. The system of claim 3, wherein the first electronic coupler is configured to communicate the weight data and the data describing the consumable product container to the third electronic coupler when the first electronic coupler and the third electronic coupler are in contact with each other.

5. The system of claim 1, wherein the first consumable product management device comprises a network interface that is configured to wirelessly communicate the weight data and the data describing the consumable product container.

6. The system of claim 1, wherein the weight sensor is a load cell.

7. The system of claim 1, wherein the weight sensor is a force sensing resistor membrane.

8. The system of claim 1, wherein the force sensing resistor membrane is coupled to the product support surface.

9. The system of claim 8, wherein the multi-protocol RFID reader is coupled to the product plate.

10. The system of claim 1, further comprising a retaining wall that is coupled to the product plate.

11. The system of claim 10, wherein the retaining wall is repositionably coupled to the product plate.

12. The system of claim 1, further comprising a plurality of retaining walls, wherein each retaining wall of the plurality of retaining walls is coupled to or proximate to a perimeter of the product plate, wherein each retaining wall of the plurality of retaining walls comprises a curved surface, and wherein each curved surface is oriented away from the perimeter of the product plate.

13. The system of claim 1, further comprising a display device coupled to a front wall of the component cover.

14. The system of claim 1, further comprising a display device coupled to a top wall of the component cover so that the display device is positioned below the product plate.

15. The system of claim 14, wherein the product plate comprises a translucent material that is positioned above the display device so that the display device is configured to illuminate the translucent material.

16. The system of claim 1, wherein the component cover comprises a front wall, and wherein a magnetic material is coupled to the front wall.

17. The system of claim 2, further comprising a post and post channel, wherein the post is mated with the post channel when the first electronic coupler and the third electronic coupler are in contact with each other.

18. The system of claim 2, wherein the first electronic coupler comprises a first magnetic coupler and the third electronic coupler comprises a second magnetic coupler, and wherein the first magnetic coupler and the second magnetic coupler are magnetically coupled together when the first electronic coupler and the third electronic coupler are in contact with each other.

19. The system of claim 1, wherein the multi-protocol RFID reader operates via a Near Field Communication (NFC) protocol.

20. The system of claim 1, wherein the multi-protocol RFID reader comprises a Radio Frequency Identification (RFID) reader.
